(19) United States
(12) Patent Application Publication
(10) Pub. No.: US 2017/0169333 A1
(43) Pub. Date: Jun. 15, 2017

(54) UTILIZING CROWD SOURCE VIEWING BEHAVIOR OF USERS TO RECOMMEND A VIEWING ORDER TO A USER

(71) Applicant: International Business Machines Corporation, Armonk, NY (US)

(72) Inventors: Al Chakra, Apex, NC (US); Jonathan Dunne, Dungarvan (IE); Liam Harpur, Dublin (IE)

(21) Appl. No.: 14/964,992

(22) Filed: Dec. 10, 2015

(51) Int. Cl. G06N 5/02; G06F 17/30

(52) U.S. Cl. CPC G06N 5/02; G06F 17/30876

(57) ABSTRACT

Utilizing a crowd source viewing behavior by context to recommend a viewing order to a user. A set of users accessing content for viewing is monitored to capture an ordered history of viewing for each user. The ordered history of viewing is analyzed to determine a context for each user and stores the context and ordered history of viewing in a repository. The ordered history of viewing from the users being monitored is then aggregated based on the determined context. A context for a new user is identified and the new user is provided with aggregated content in a viewing order defined by the identified context based on aggregated order history of monitored users.

### BACKGROUND

The present invention relates to crowd source viewing behavior, and more specifically to utilizing crowd source viewing behavior of users to recommend a view order to a user.

Users view content for different reasons or in different contexts. For example, looking at a topic to learn characteristics of the topic, a beginner may view different content or view content in different order, than a user with advanced knowledge looking at the topic for reference purposes. It would be beneficial for a user to be able to view content in an order based on crowd source viewing behavior which takes into account context.

### SUMMARY

According to one embodiment of the present invention, a method of utilizing crowd source viewing behavior by context to recommend a viewing order to a user is disclosed. The method comprising the steps of: a computer monitoring a set of users accessing content for viewing to capture an ordered history of viewing for each user; the computer analyzing the ordered history of viewing to determine a context for each user and storing the context and ordered history of viewing in a repository; the computer aggregating the ordered history of viewing from the users being monitored based on the determined context; the computer identifying a context for a new user; and the computer providing the new user with aggregated content in a viewing order defined by the identified context based on aggregated order history of monitored users.

According to another embodiment of the present invention, a computer program product for utilizing crowd source viewing behavior by context to recommend a viewing order to a user is disclosed. The computer program product comprising a computer comprising at least one processor, one or more memories, one or more computer readable storage media, the computer program product comprising a computer readable storage medium having program instructions embodied therewith, the program instructions executable by the computer to perform a method comprising: monitoring, by the computer, a set of users accessing content for viewing to capture an ordered history of viewing for each user; analyzing, by the computer, the ordered history of viewing to determine a context for each user and storing the context and ordered history of viewing in a repository; aggregating, by the computer, the ordered history of viewing from the users being monitored based on the determined context; identifying, by the computer, a context for a new user; and providing, by the computer, the new user with aggregated content in a viewing order defined by the identified context based on aggregated order history of monitored users.

According to another embodiment of the present invention, a computer system for utilizing crowd source viewing behavior by context to recommend a viewing order to a user is disclosed. The computer system comprising a computer comprising at least one processor, one or more memories, one or more computer readable storage media having program instructions executable by the computer to perform the program instructions. The program instructions comprising: monitoring, by the computer, a set of users accessing content for viewing to capture an ordered history of viewing for each user; analyzing, by the computer, the ordered history of viewing to determine a context for each user and storing the context and ordered history of viewing in a repository; aggregating, by the computer, the ordered history of viewing from the users being monitored based on the determined context; identifying, by the computer, a context for a new user; and providing, by the computer, the new user with aggregated content in a viewing order defined by the identified context based on aggregated order history of monitored users.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flow diagram of a method of utilizing crowd source viewing behavior of users to recommend a viewing order to a user.

FIG. 3 illustrates internal and external components of a client computer and a server computer in which illustrative embodiments may be implemented.

### DETAILED DESCRIPTION

In an illustrative embodiment of the present invention, it is recognized that over a period of time, context may be assigned to reading behavior of users. The behavior of the user or the context of the content which the user chooses is cross-referenced to extract core concepts and assemble an understanding for consumption by other consumers or users of the same or similar content. Based on the core concepts, commonalities are extracted to detect surface point-in-time commonalities in behavior.

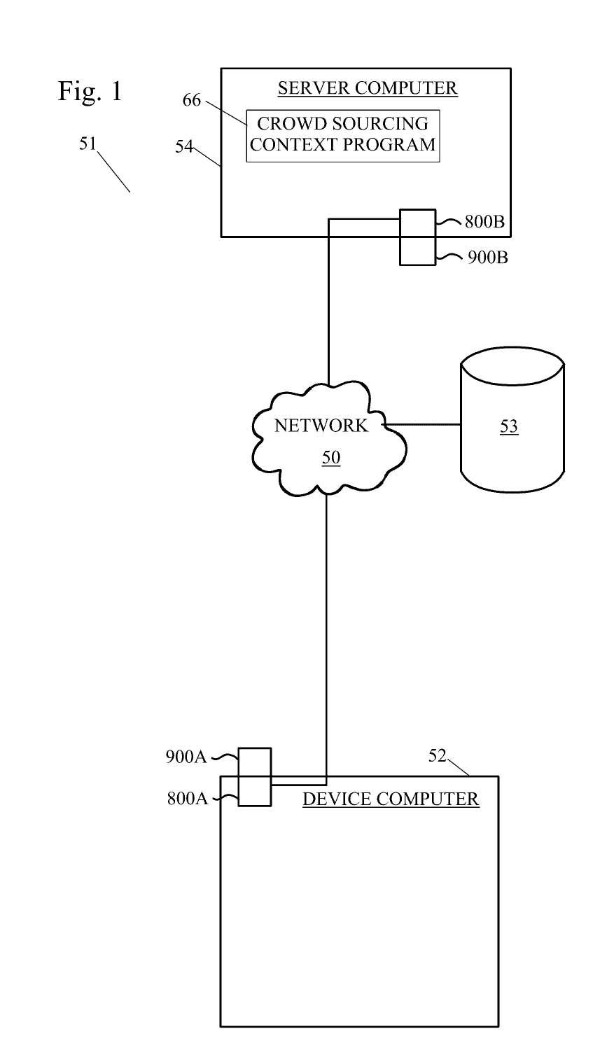

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, client computer 52, storage unit 53, and server computer 54 connect to network 50. In other exemplary embodiments, network data processing system 51 may include additional client computers, storage devices, server computers, and other devices not shown.

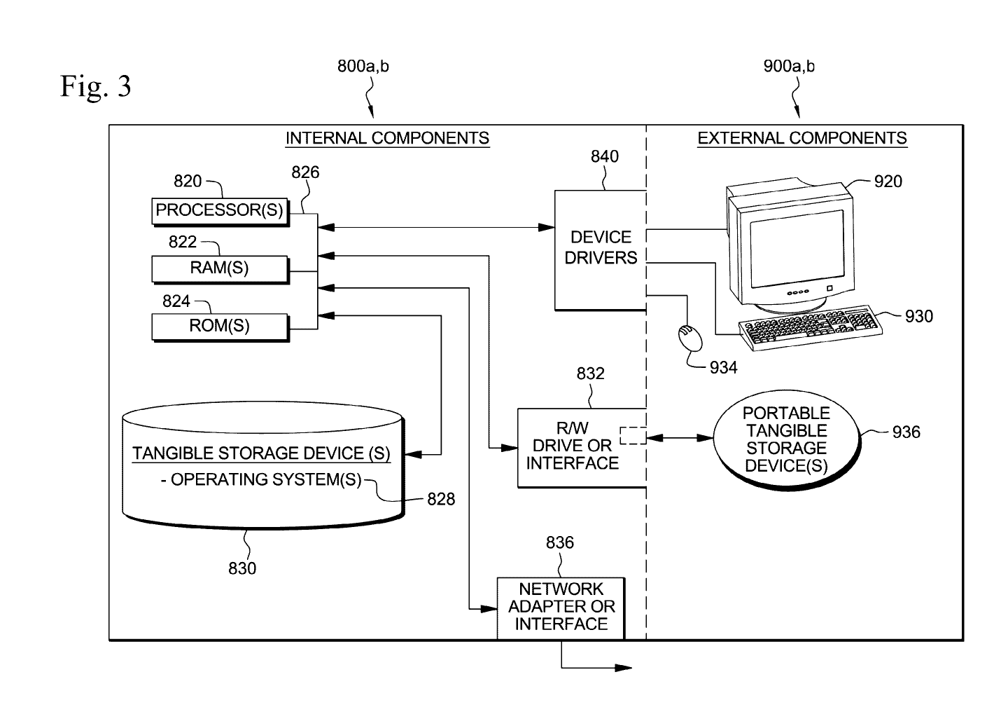

Client computer 52 includes a set of internal components 800a and a set of external components 900a, further illustrated in FIG. 3. Client computer 52 may be, for example, a mobile device, a cell phone, a personal digital assistant, a netbook, a laptop computer, a tablet computer, a desktop computer, or any other type of computing device.

Client computer 52 may contain an interface. Through the interface, users may view an ordered history based on context. The interface may accept commands and data entry from a user, such as viewing behavior of a user. The interface can be, for example, a command line interface, a graphical user interface (GUI), or a web user interface (WUI).

Server computer 54 includes a set of internal components 800b and a set of external components 900b illustrated in FIG. 3. Server computer 54 may contain an interface. The interface can be, for example, a command line interface, a graphical user interface (GUI), or a web user interface (WUI) through which a crowd sourcing context program 66 may be accessed. Alternatively, the crowd sourcing context program 66 may be on client computer 52.

In the depicted example, server computer 54 provides information, such as boot files, operating system images, and applications to client computer 52. Server computer 54 can compute the information locally or extract the information from other computers on network 50.

Program code and programs such as crowd sourcing context program 66 may be stored on at least one of one or more computer-readable tangible storage devices 830 shown in FIG. 3, on at least one of one or more portable computer-readable tangible storage devices 936 as shown in FIG. 3, or on storage unit 53 connected to network 50, or may be downloaded to a computer, such as client computer 52 or server computer 54, for use. For example, program code and programs such as crowd sourcing context program 66 may be stored on at least one of one or more storage devices 830 on server computer 54 and downloaded to client computer 52 over network 50 for use on client computer 52. Alternatively, server computer 54 can be a web server, and the program code, and programs such as crowd sourcing context program 66 may be stored on at least one of the one or more storage devices 830 on server computer 54 and accessed on client computer 52. In other exemplary embodiments, the program code, and programs such as crowd sourcing context program 66 may be stored on at least one of one or more computer-readable storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

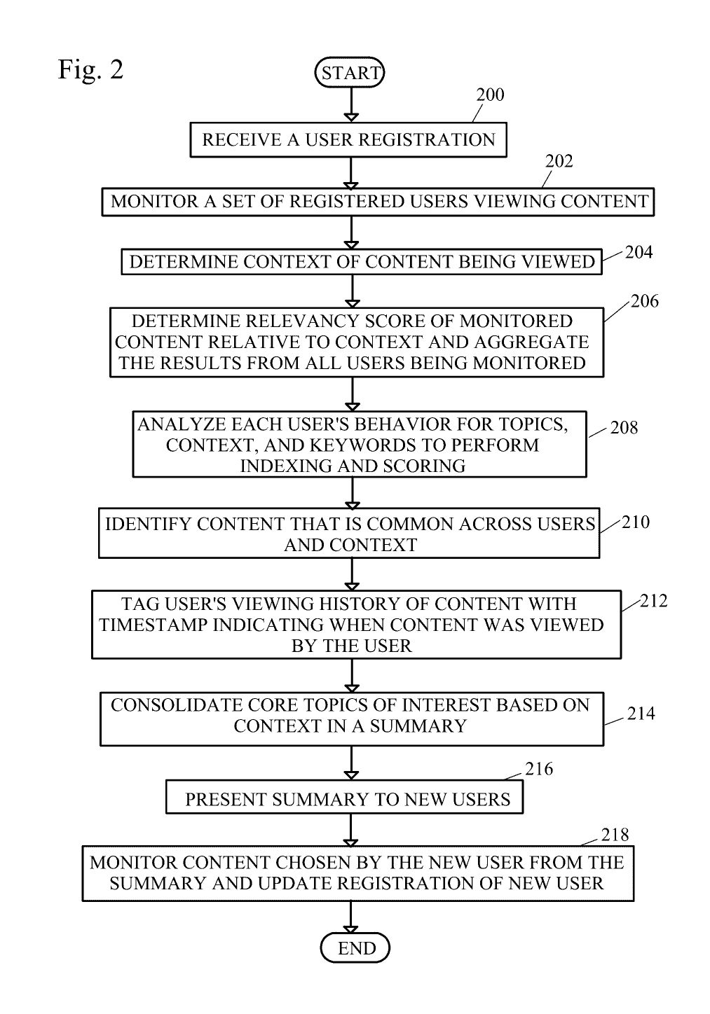

FIG. 2 shows a flow diagram of a method of utilizing crowd source viewing behavior of users to recommend a viewing order to a user.

In a first step, a crowd source context program 66 receives a user registration (step 200). The user registration may include, but is not limited to temporal context perspective. The temporal context perspective is an updatable context from a point of view of interpretation. The temporal context perspective may include topics or characteristics that define a perspective a user is interested in. The temporal context perspective is dynamic and self-learning.

The topics of characteristics may be predetermined by the crowd source context program 66 and updated based on actions of the user. For example, if the temporal context perspective for a user is front end software engineer, topics such as programming languages, frameworks, etc . . . may be included. If the temporal context perspective for a user is back end software engineer, topics such as server side programming language, frameworks, other programming languages, security, etc . . . may be included. The temporal context perspective provides topics that form the setting for an event, statement, or idea which may be of interest to the user.

Alternatively, the topics of the temporal context perspective may be editable by the user.

Crowd sourcing context program 66 monitors a set of registered users and the content which the registered users are viewing relative to the temporal context perspective (step 202). The content being viewed is preferably content that can be tracked. The content may be found in webpages, web posts, articles, or other printed or electronically distributed materials. It should be noted that the content is not limited to text. The monitoring may be done by a server computer 54 or by a program on the client computer 52.

It should be noted that the monitoring includes activities which occur prior to and following viewing of specific content. For example, searches conducted to find specific articles, viewing of the specific article and searches conducted after the specific article was read, such as additional searches or viewing of associated content or links from the specific article.

It should be noted that as monitoring of users viewing content continues, the core topics of interest in the temporal context perspective may be updated as content is discovered and considered to be relevant based on context. For example, as new articles, images, or media is published or made available.

The context of content being viewed is determined and is stored in a repository (step 204). The repository may be repository 53. As used in this description, the term “context” means the category of behavior engaged in and this can be ascertained by taxonomy analysis—that is, by understanding the category of behavior engaged in. For example, if a user is viewing several articles related to Java encryption overviews, then the context program 66 would thereby determine that the context is “Security-Java”. On the other hand, if the user is viewing debugging tools as part of a work project, then context program 66 would determine that the context is “Debugging-Java”.

A relevancy score of the monitored content relative to context is determined, and the relevancy scores of the content from all of the users in a context are aggregated (step 206), for example by the crowd sourcing context program 66. The context may be users with the similar topics within their temporal context perspective.

A relevancy score may be determined by a comparison of the behaviors with a defined group or users with the same temporal context perspective. For example, if User A or Group 1 is known to be engaged in “Security-Java”, then the behaviors of that group can be used as a comparison. For example, if that group and the studied user opened a particular database and created specific document types then the relevancy score may reach a significant threshold. Time spent viewing or number of times viewed by a user of content may also contribute to the relevancy score.

Each of the users' viewing behavior is analyzed for topics, context, and keywords to perform indexing and scoring (step 208). The indexing and scoring may be performed using a generalized linear regression model.

Content that is common across users in a same determined context or temporal context perspective is identified (step 210). A user's viewing history of content is tagged with a timestamp indicating when the content was viewed by a user (step 212).

The core topics of interest based on context are consolidated in a summary (step 214).

The summary is presented to new users based on context and/or content (step 216). It should be noted that the new users may be part of the set of users being monitored for other content/context and preferably each include a temporal context perspective.

The crowd sourcing context program 66 monitors content chosen from the summary by the new user relative to the temporal context perspective of the new user (step 218) and the method ends or may return to step 202 of monitoring a set of registered users viewing content.

As part of step 218 of monitoring the content chosen from the summary, the crowd sourcing context program 66 analyzes content chosen from the summary by the user to identify topics and context and increase the relevancy of the identified topics and context relative to a user's temporal context perspective, which can be applied to further monitoring. The increased relevancy of the identified topics and context may be applied to a same context perspective of multiple users.

Additionally, the crowd source context program 66 may analyze the content not chosen from the summary by identifying the topics and context of the content and decrease the relevancy of the identified topics and context relative to a user's temporal context perspective, which can be applied to further monitoring. The decreased relevancy of the identified topics and context may be applied to a same context perspective of multiple users.

It should be noted that the different contexts or perspectives are now known based on the relevancy scores (e.g. “Debugging-Java” and “Security-Java”), and so the navigation path taken by the user or group is used both to infer the context and in others to understand the use of a particular page.

For example, multiple users are being monitored and found to be viewing information regarding “Java”. User C or group C reads a web page related to the “Implementation of Java platform” with the intent of learning (context) about the programming language. User B or group B reads the same web page with a relative high priority related to “security” with the intent of learning more potential security vulnerabilities (context) specific to the Java platform. A relevancy score of the content being viewed relative to the context is determined. The scoring is completed using a linear regression model for three webpages being viewed is shown in Table 1. The content of the three webpages are viewed by users for different contexts—learning, security, debugging etc . . . . The user's viewing history is time stamped and a summary of user viewing histories for different contexts is created.

For example, in the context of a Java security incident, the summary may include the webpages listed in the following order: webpage 2, webpage 3, and webpage 1. For learning how to program in Java, the webpage may be listed in the following order: webpage 1, webpage 3 and webpage 2. For a user looking for information regarding debugging in Java, the webpages may be listed in the following order: webpage 1, webpage 3, and webpage 2. While only three webpages are shown in the example, multiple entries of webpages or other media may be listed.

TABLE 1

| | UserContext | | |
|---|---|---|---|
| Content | Learning | SecurityIncident | Debugging |
| Webpage1: Basics | 34.10% | 54.00% | 81.90% |
| of Java | | | |
| Webpage2: Security | 12.00% | 72.60% | 32.50% |
| Vulnerabilites of | | | |
| Java Platform | | | |
| WebPage3: | 22.00% | 65.20% | 76.50% |
| Implementation of | | | |
| Java Platform | | | |

The order and content viewed from the summary is monitored. If a user is viewing the webpages in a context of learning how to program in Java and only views webpage 1 and webpage 3 and not webpage 2, the topic of vulnerabilities of Java may be a topic that decreases in relevancy for the future for users viewing content in the temporal context perspective of a low level Java programmer

FIG. 3 illustrates internal and external components of client computer 52 and server computer 54 in which illustrative embodiments may be implemented. In FIG. 3, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, crowd sourcing context program 66 are stored on at least one of one or more of the computer-readable tangible storage devices 830 for execution by at least one of one or more of the processors 820 via at least one of one or more of the RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Crowd sourcing context program 66 can be stored on at least one of one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Crowd sourcing context program 66 can be downloaded to client computer 52 and server computer 54 from an external computer via a network (for example, the Internet, a local area network or other, wide area network) and network adapter or interface 836. From the network adapter or interface 836, crowd sourcing context program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Crowd sourcing context program 66 can be written in various programming languages including low-level, high-level, object-oriented or non object-oriented languages. Alternatively, the functions of crowd sourcing context program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of utilizing crowd source viewing behavior by context to recommend a viewing order to a user comprising the steps of:
a computer monitoring a set of users accessing content for viewing to capture an ordered history of viewing for each user;
the computer analyzing the ordered history of viewing to determine a context for each user and storing the context and ordered history of viewing in a repository;
the computer aggregating the ordered history of viewing from the users being monitored based on the determined context;
the computer identifying a context for a new user; and
the computer providing the new user with aggregated content in a viewing order defined by the identified context based on aggregated order history of monitored users.

2. The method of claim 1, wherein the context is identified through taxonomy analysis.

3. The method of claim 1, wherein the analysis is determined by a generalized linear regression model.

4. The method of claim 1, wherein the content being viewed by users during monitoring is timestamped.

5. The method of claim 1, further comprising the computer receiving a context perspective of a user relative to the content being viewed.

6. The method of claim 5, wherein the context perspective comprises a plurality of topics and is alterable based on content viewed.

7. The method of claim 1, further comprising the step of monitoring the viewing content of the new user from the aggregated order history.

8. A computer program product for utilizing crowd source viewing behavior by context to recommend a viewing order to a user comprising a computer comprising at least one processor, one or more memories, one or more computer readable storage media, the computer program product comprising a computer readable storage medium having program instructions embodied therewith, the program instructions executable by the computer to perform a method comprising:
monitoring, by the computer, a set of users accessing content for viewing to capture an ordered history of viewing for each user;
analyzing, by the computer, the ordered history of viewing to determine a context for each user and storing the context and ordered history of viewing in a repository;
aggregating, by the computer, the ordered history of viewing from the users being monitored based on the determined context;
identifying, by the computer, a context for a new user; and
providing, by the computer, the new user with aggregated content in a viewing order defined by the identified context based on aggregated order history of monitored users.

9. The computer program product of claim 8, wherein the context is identified through taxonomy analysis.

10. The computer program product of claim 8, wherein the analysis is determined by a generalized linear regression model.

11. The computer program product of claim 8, wherein the content being viewed by users during monitoring is timestamped.

12. The computer program product of claim 8, further comprising receiving, by a computer, a context perspective of a user relative to the content being viewed for each of the users.

13. The computer program product of claim 12, wherein the context perspective comprises a plurality of topics and is alterable based on content viewed.

14. The computer program product of claim 8, further comprising the program instructions of monitoring, by the computer, the viewing content of the new user from the aggregated order history.

15. A computer system for utilizing crowd source viewing behavior by context to recommend a viewing order to a user comprising a computer comprising at least one processor, one or more memories, one or more computer readable storage media having program instructions executable by the computer to perform the program instructions comprising:
monitoring, by the computer, a set of users accessing content for viewing to capture an ordered history of viewing for each user;
analyzing, by the computer, the ordered history of viewing to determine a context for each user and storing the context and ordered history of viewing in a repository;
aggregating, by the computer, the ordered history of viewing from the users being monitored based on the determined context;
identifying, by the computer, a context for a new user; and
providing, by the computer, the new user with aggregated content in a viewing order defined by the identified context based on aggregated order history of monitored users.

16. The computer system of claim 15, wherein the context is identified through taxonomy analysis.

17. The computer system of claim 15, wherein the analysis is determined by a generalized linear regression model.

18. The computer system of claim 15, wherein the content being viewed by users during monitoring is timestamped.

19. The computer system of claim 8, further comprising receiving, by a computer, a context perspective of a user comprising a plurality of topic relative to the content being viewed for each of the users, whereby the context perspective is alterable based on content viewed.

20. The computer system of claim 15, further comprising the program instructions of monitoring, by the computer, the viewing content of the new user from the aggregated order history.
